(19) United States
(12) Patent Application Publication
(10) Pub. No.: US 2014/0297882 A1
(43) Pub. Date: Oct. 2, 2014

(54) DYNAMIC TRACK SWITCHING IN MEDIA STREAMING

(71) Applicant: MICROSOFT CORPORATION, Redmond, WA (US)

(72) Inventors: Stephen J. Estrop, Carnation, WA (US); Matthew Howard, Bothell, WA (US); Marcin Stankiewicz, Redmond, WA (US); Shijun Sun, Redmond, WA (US)

(73) Assignee: Microsoft Corporation, Redmond, WA (US)

(21) Appl. No.: 13/854,849

(22) Filed: Apr. 1, 2013

(51) Int. Cl. H04L 29/06

(52) U.S. Cl. CPC H04L 65/60
USPC 709/231

(57) ABSTRACT

A switching module is adapted to configure switches between source buffers and rendering pipelines. Each of the switches has one or more selection inputs each representing encoded data for a media track from one of the source buffers. Each of the switches also has a selection output associated with one of the rendering pipelines for decoding and rendering. The switching module is further adapted to use the switches to manage which of the media tracks, if any, have encoded data routed to the rendering pipelines during media streaming. The rendering pipelines can include a video rendering pipeline and one or more audio rendering pipelines, where the switching module is part of a media engine adapted to determine a clock source in one of the audio rendering pipeline(s), and the clock source is used to drive synchronization of the media tracks.

### BACKGROUND

A common challenge for media playback in media streaming scenarios is how to handle media track switching as well as adding or removing media tracks seamlessly. Another challenge is how to handle changes to sources of media content, for example, as sources are added or removed.

One possible solution is to allow multiple tracks to be decoded simultaneously, with only selected tracks being rendered to a display or speakers. For example, each track may be sent to a separate decoder, and a selected one of the tracks may be output to a separate renderer. This, however, has negative implications in terms of system resource cost, power consumption, and network bandwidth cost for streaming of media content.

Another possible solution is to switch tracks (e.g., an audio track) in a more brute-force manner, where the system tries to synchronize playback of samples from a video stream and samples from audio streams with a best effort approach. However, continuously keeping video samples and audio samples in sync, in a way that is virtually glitch free or seamless, is challenging.

### SUMMARY

In summary, innovations are described for managing dynamic track switching during media streaming. For example, with a switching module, a media engine configures one or more switches between one or more source buffers and one or more rendering pipelines, and uses the switch(es) to manage which of the media tracks, if any, have encoded data routed to the rendering pipeline(s) during media streaming. Each of the switch(es) may have one or more selection inputs, each representing encoded data for a media track from one of the source buffer(s), as well as a selection output associated with a different one of the rendering pipeline(s) for decoding and rendering. In this way, the media engine can dynamically manage the switching of tracks in media streaming.

The management of dynamic track switching can be implemented as part of a method, as part of a computer system adapted to perform the method or as part of a tangible computer-readable media storing computer-executable instructions for causing a computer system to perform the method.

For example, a computer system instantiates a switching module, configures one or more switches of the switching module between one or more source buffers and one or more rendering pipelines, and uses the switch(es) to manage which of the media tracks from the source buffer(s), if any, have encoded data routed to the rendering pipeline(s) during media streaming. Each of the switch(es) may have one or more selection inputs, each representing encoded data for a media track from one of the source buffer(s), as well as a selection output associated with a different one of the rendering pipeline(s).

Or, as another example, a computer system implements a streaming media processing pipeline. The streaming media processing pipeline includes one or more source buffers and a media engine separated by an application programming interface (“API”) from the source buffer(s). The media engine includes one or more rendering pipelines and a switching module, where the rendering pipeline(s) include a video rendering pipeline and one or more audio rendering pipelines. The video rendering pipeline includes a video decoder and video renderer, and each of the audio rendering pipeline(s) includes an audio decoder and an audio renderer. The switching module is adapted to configure one or more switches between the source buffer(s) and the rendering pipeline(s) and use the switches to manage which of the media tracks, if any, have encoded data routed to the rendering pipeline(s) during media streaming. Each of the switch(es) may have one or more selection inputs, each representing encoded data for a media track from one of the source buffer(s), as well as a selection output associated with a different one of the rendering pipeline(s). The switching module may be adapted to, as part of management of the media tracks during the media streaming, switch which media track has encoded data routed to one of the rendering pipeline(s), and add or remove a media track as selection input of one of the switch(es).

The foregoing and other objects, features, and advantages of the invention will become more apparent from the following detailed description, which proceeds with reference to the accompanying figures.

### BRIEF DESCRIPTION OF THE DRAWINGS

FIGS. 1-5 are flowcharts illustrating example approaches to implementing switching operations with a switching module.

FIG. 6 is a diagram of an example architecture with a switching module, the architecture including one video rendering pipeline and one audio rendering pipeline.

FIG. 7 is a diagram of an example architecture with a switching module, the architecture including one video rendering pipeline and multiple audio rendering pipelines.

FIG. 8 is a block diagram of an example computer system in which some described innovations may be implemented.

### DETAILED DESCRIPTION

Innovations are described for managing dynamic track switching during media streaming. For example, a switching module may configure switches between source buffers and rendering pipelines, and use the switches to manage which of the media tracks from one of the source buffers, if any, have encoded data routed to the rendering pipelines during media streaming. Each of the switches may have one or more selection inputs each representing encoded data for a media track from one of the source buffers, and a selection output associated with a different one of the rendering pipelines for decoding and rendering. In common use scenarios, the switching module can dynamically manage the switching of tracks in media streaming, for example, switch media tracks in response to user input or other input, add or remove a media track as a selection input of one of the switches, or even add or remove a source buffer and then update the selection inputs of the switches. In this way, even when the rendering pipelines are fixed during media streaming, the switching module can adapt dynamically during media streaming to changes to the source buffers, media tracks, or user selections. The switching module can thus provide an adaptive front-end for media rendering pipelines with fixed functionality in a computer system.

In some implementations of a media switching module, in various media streaming scenarios, the innovations enable (a) seamless media track switching operations using the media switching module; (b) seamless addition or removal of media tracks using the media switching module; (c) seamless playback of multiple audio tracks and a video track while keeping all of the tracks synchronized; and (d) signaling of metadata about track switching so as to support interactive control operations with media playback applications or systems. The various aspects of the innovations described herein can be used in combination or separately.

### Techniques for Managing Switching in Media Streaming

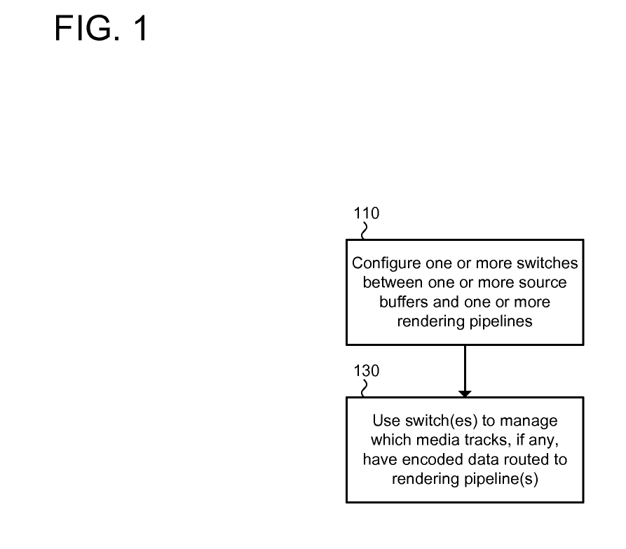

FIG. 1 is a flowchart illustrating an example approach to managing switching operations with a switching module. The switching module can be part of a media engine of an operating system or part of another media processing tool. In FIGS. 1-5, like reference numerals denote like elements and therefore repeated descriptions will be omitted.

At 110, the switching module configures one or more switches between one or more source buffers and one or more rendering pipelines. Each switch is associated with a different one of the rendering pipeline(s). The rendering pipeline(s) can include a video rendering pipeline and one or more audio rendering pipelines. The source buffer(s) and media tracks are dynamic during the media streaming, but the rendering pipeline(s) are fixed during the media streaming. Each switch is configured to receive one or more of the media tracks as selection inputs and configured to output a selected media track as a selection output to the corresponding rendering pipeline for decoding and rendering. The switching module determines which media tracks are to be routed to each switch for potential output to a rendering pipeline. Since the number of selection inputs may vary over the course of a playback session, the switching module manages the switch(es) to ensure that media tracks are appropriately routed to the proper switch.

At 130, the switching module uses the switch(es) to manage which media tracks, if any, have encoded data routed to rendering pipeline(s). Each switch manages which of the media tracks, if any, for selection inputs of the switch have encoded data routed to the rendering pipeline associated with that switch during media streaming.

For example, in operation, the switching module receives media tracks from one or more source buffers. Each source buffer contains one or more video and/or audio tracks (media tracks). The number of source buffers may vary over the course of a playback session (during media streaming), as can the number of media tracks. Since the source buffers and media tracks are dynamic during the media streaming, the switching module is configured to maintain a list of current source buffers and media tracks, and to add and remove source buffers and/or media tracks from the list as their statuses change over the course of the media streaming. The one or more media tracks received by the switching module are associated with selection inputs of the one or more switches, where each of the selection inputs represent encoded data for a media track from one of the source buffers.

At a high level, the switching module selects the media tracks to output. Although the source buffers contain data for multiple media tracks, the user may be only interested in a single audio track and a single video track. For example, the source buffers may contain audio tracks for multiple languages, but the user may only be interested in an English language track. Therefore, the switching module may select the English language track among the audio tracks associated with selection inputs at a switch. The switching module also selects the rendering pipelines for decoding and rendering. Each of the rendering pipelines includes a media decoder and a media renderer. Once the number of rendering pipelines is set for a playback session, the number remains fixed during the media streaming.

The switching module routes the selected media tracks to the selected rendering pipelines. Each of the switches can receive one or more of the media tracks, but may only route one media track to its associated rendering pipeline. Thus, using the one or more switches, the switching module manages how the one or more media tracks are routed to the rendering pipeline(s).

The source buffers temporarily store encoded data for one or more media tracks, and then provide the encoded data for routing by the switching module.

The switching module need not balance the media tracks between the switches. For example, in some cases, at least one of the switches has multiple selection inputs, and at least one of the switches has a single selection input. The switching module determines which of the switches receive which of the input media tracks. The switching module may route media tracks to selection inputs of the switches based on, for example, content type (e.g., audio or video). Thus, if multiple media tracks have the same content type, they may be routed to the same switch. Or, the switching module may route media tracks to selection inputs of the switches based on, for example, program information that specifies which media tracks provide alternative versions of the same content. The alternative versions of the content can differ in terms of language (e.g., English, French, Spanish), content rating (e.g., uncensored, censored), or other characteristics of the underlying media content. Or, the alternative versions of the content can differ in terms of bitrate and quality of encoding (e.g., high bitrate and quality, intermediate bitrate and quality, low bitrate and quality) or other processing applied to the underlying media content.

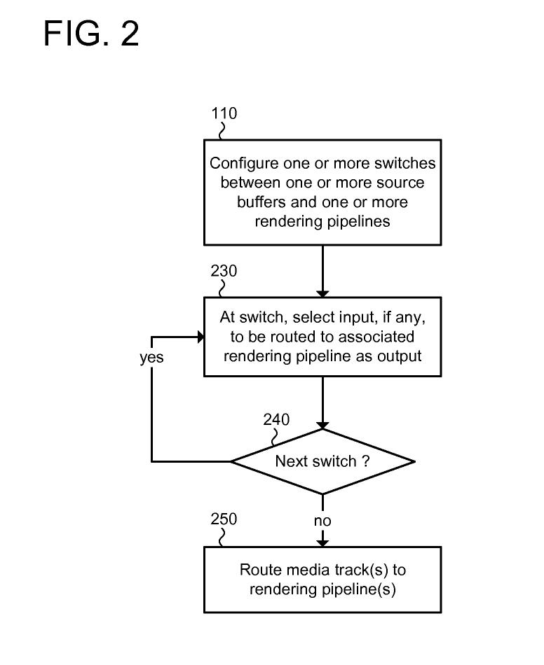

FIG. 2 is a flowchart illustrating an example approach to implementing routing operations with a switching module. The switching module can be part of a media engine of an operating system or part of another media processing tool.

At 110, the switching module configures one or more switches between source buffer(s) and rendering pipeline(s), as described with reference to FIG. 1.

At 230, for a given switch, the switching module selects inputs, if any, to be routed to the rendering pipeline associated with the given switch. For example, the switching module selects among alternative versions of content for the selection inputs of the given switch. The switching module can select a selection input for the given switch based upon user input, input from a media application, or other information. In some cases, the switching module selects none of the available selection inputs for the given switch.

At 240, the switching module continues with the next switch, selecting (230) input for that switch to be routed to the rendering pipeline associated with that switch. When there are no more switches to manage, at 250, the switching module routes media tracks for the selected inputs to the appropriate rendering pipelines.

### Techniques for Switching a Track or Source Buffer in Media Streaming

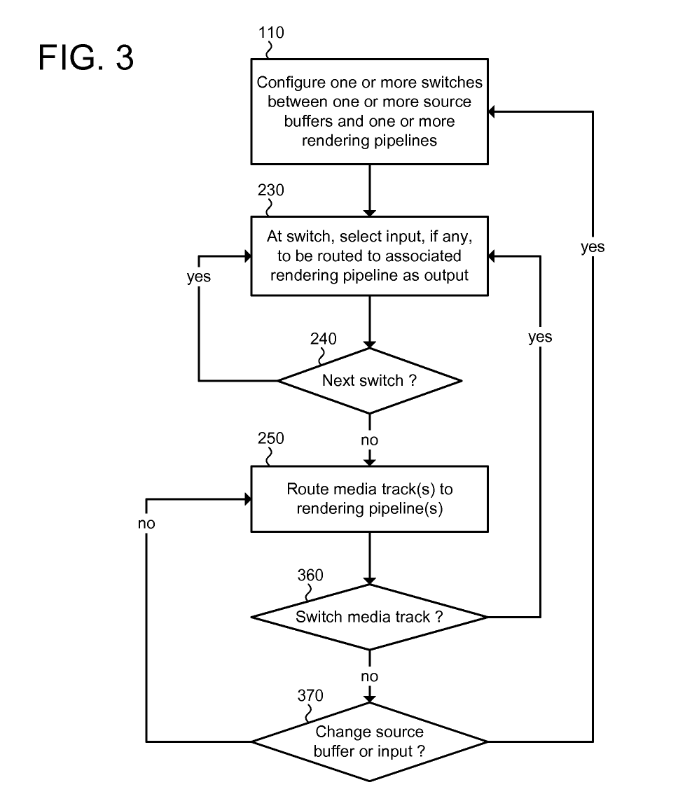

FIG. 3 is a flowchart illustrating example approaches to implementing track or buffer switching operations with a switching module. The switching module can be part of a media engine of an operating system or part of another media processing tool. In these examples, source buffers and media tracks may be added or removed. Further, media tracks may also be switched.

At 110, the switching module configures one or more switches between source buffer(s) and rendering pipeline(s), as described with reference to FIG. 1. At 230-250, the switching modules selects inputs, if any, to be routed to the rendering pipelines, and routes media tracks for the selected inputs to the appropriate rendering pipelines, as described with reference to FIG. 2.

At 360, the switching module determines whether to switch any of the media tracks. If so, for a given switch, the switching module reevaluates the selection (230) of input to be routed to the associated rendering pipeline for the given switch. The switching module can continue reevaluating the selection of input for other switches (230, 240), if appropriate.

The switching module can determine to switch media tracks based on user input, input from a media application, or other information. If the switching module receives a command to switch media tracks, the switching module may switch the currently output media track to a new media track. If the media track is switched, the process flows to step 230, where the switched media track having encoded data is selected for routing to one of the rendering pipelines. Or, a media engine may receive user input to switch media tracks, and convey that user input to the switching module within the media engine. The media engine may also include the rendering pipelines and be separated by an API from the source buffers. When the media engine is adapted to provide status information to media playback applications about track-related operations, the media engine can also receive track selection input from such media playback applications, which the switching module uses to switch media tracks.

At 370, the switching module determines whether there has been any change to the source buffers (e.g., adding a source buffer, removing a source buffer) or media tracks provided as input from the source buffers (e.g., adding a media track, removing a media track). If so, the switching module re-configures (110) the switch(es) between the source buffer(s) and rendering pipeline(s). If not, the switching module continues routing (250) media tracks as selected by the switching module.

Thus, if a source buffer is to be added or removed, or a media track is to be added or removed as a selection input of one the switch(es), the process flows to step 110, where the switching module re-configures the switch(es). For example, a source buffer may not have any more data to send to the switching module or may become inactive, so that the switching module removes the source buffer from the managed list. If the source buffer is removed, the selection inputs of the switch(es) that were previously configured to receive media information from the source buffer are updated. If the removed source buffer was previously sending a media track that was routed to one of the rendering pipeline(s), the switching module can select (230) a new media track to output, or select no track for routing to its associated rendering pipeline. Or, as another example, if a new source buffer is added to provide new media content, the switching module updates selection inputs of one or more switch(es) to receive media tracks from the new source buffer. Or, as another example, if the media tracks provided through an existing source buffer change, the switching module updates selection inputs of one or more switch(es) to receive media tracks that are currently available. In this way, the switching module is adapted to add or remove a media track as a selection input of one of the switch(es), or to add or remove a source buffer, where removing or adding a source buffer results in updating the selection inputs of the switch(es).

### Techniques for Providing and Updating Metadata in Media Streaming

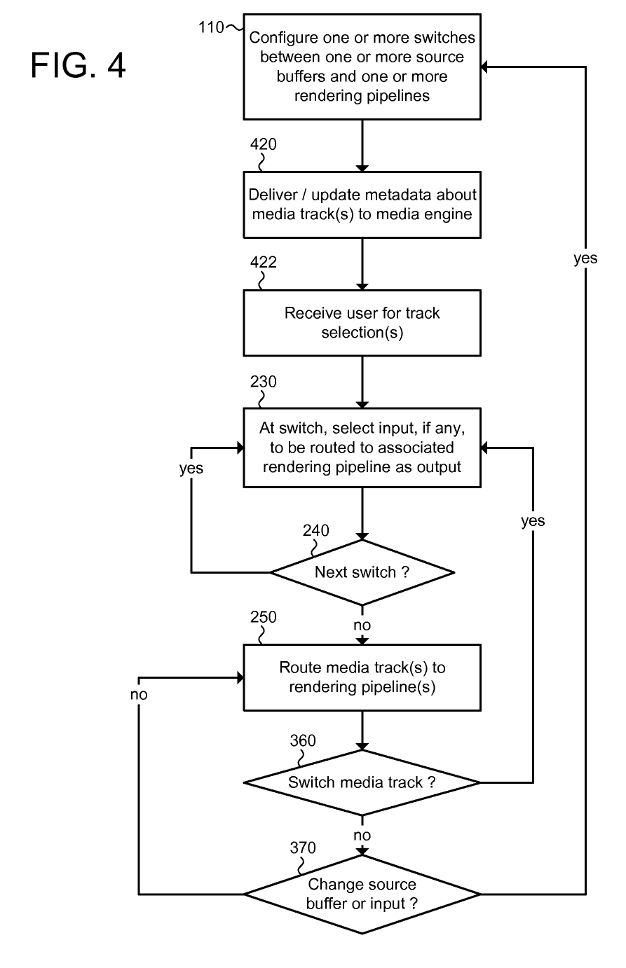

FIG. 4 is a flowchart illustrating example approaches to providing and updating metadata about media tracks with a switching module. The switching module can be part of a media engine of an operating system or part of another media processing tool.

At 110, the switching module configures one or more switches between source buffer(s) and rendering pipeline(s), as described with reference to FIG. 1. At 230-250, the switching modules selects inputs, if any, to be routed to the rendering pipelines, and routes media tracks for the selected inputs to the appropriate rendering pipelines, as described with reference to FIG. 2. At 360-370, the switching module selectively switches media tracks and/or source buffer(s), as described with reference to FIG. 3.

Turning to FIG. 4, after configuring/re-configuring (110) the switch(es) between source buffer(s) and media rendering pipeline(s), at 420, the switching module delivers metadata (or, where metadata has previously been delivered, updates the metadata) about one or more media tracks to a media engine. The metadata indicates how many media tracks are available, properties of at least some of the media tracks (e.g., language, number of channels, etc.), or other information about the media tracks. The media engine may expose the information to an end user through a user interface, so that the user can select one or more of the media tracks. Or, the media engine can convey the metadata to one or more media playback applications or otherwise use the metadata about the media tracks.

At 422, the switching module receives input for one or more track selections, which the switching module uses to select inputs, if any, to be routed to the rendering pipeline(s). The input can be user input, input from a media playback application, or other information from the media engine or another source. When the media engine receives track selection input, it is responsible for relaying the track selection information to the switching module. The track selection input indicates how to use to switch(es) to manage the media tracks. For example, if a user selects a track that is different from the media track currently being output, the switch will route the newly selected track to it corresponding rendering pipeline and discontinue output of the old track.

At 420, if one of the media tracks has been switched, the media engine receives updated metadata about the media tracks. The media engine also receives updated metadata after addition of one of the media tracks, removal of one of the media tracks, addition of one of the source buffers, or removal of one of the source buffers.

### Techniques for Synchronizing Video Track with Audio Track in Media Streaming

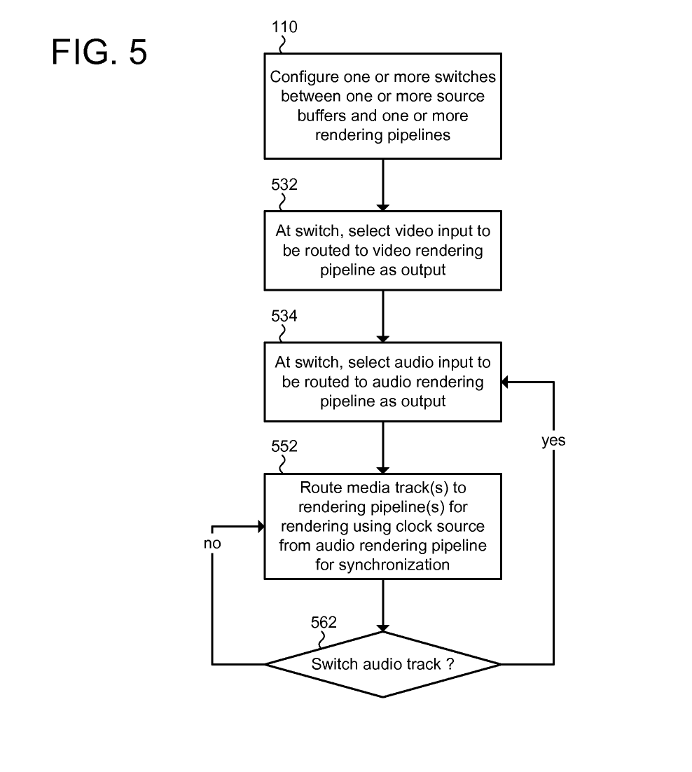

FIG. 5 is a flowchart illustrating example approaches to synchronizing playback operations with a switching module. The switching module can be part of a media engine of an operating system or part of another media processing tool. In these examples, the switching module synchronizes the output media tracks to a single clock source, determining the clock source in one or more of the audio rendering pipelines.

At 110, the switching module configures one or more switches between source buffer(s) and rendering pipeline(s), as described with reference to FIG. 1.

At 532, the switching module selects a video input to be routed to a video rendering pipeline. At 534, the switching module selects an audio input be routed to an audio rendering pipeline. At 552, the switching module routes media tracks to the rendering pipelines for rendering, using a clock source from the audio rendering pipeline for synchronization.

For example, the switching module selects an audio track to be routed to the audio rendering pipeline that includes the clock source. This audio rendering pipeline will be used as a synchronization clock. The clock source may be from a sound card. Many modern sound cards, for example, use a crystal that provides clock pulses for timing. Since this clock source has a relatively high degree of accuracy, by synchronizing other tracks to the selected audio track, the system may be able to avoid the scenario where the one or more media tracks become out of sync. The selected video track is synchronized with the selected audio track. To synchronize the video track with the audio track, both media tracks use the same clock source. If the video track gets out of sync, the video track may add (by interpolation or frame repetition) or drop frames to stay synchronized with the audio track. Thus, the encoded data for the video track is routed to the video rendering pipeline, and playback of the video track is synchronized with playback of the audio track using the clock source to drive synchronization.

In the above example, a single audio track and a single video track are output. However, the media engine can also handle the situation where the audio track is switched during playback. Returning to FIG. 5, at 562, the switching module determines whether to switch audio tracks. If so, the switching module reevaluates the selection (534) of audio input to be routed to the audio rendering pipeline.

Or, instead of changing audio tracks, a user may select to change the video track to another video track. Alternatively, the media engine may provide a second video track to replace the video track. Either way, the encoded data for the second video track is routed to the video rendering pipeline. In order to ensure that switch of the video tracks appears seamless, the second video track is also synced with the selected audio track (534, 552). Playback of the second video track is synchronized with playback of the selected audio track using the clock source (from the audio rendering pipeline used for the selected audio track) to drive synchronization. Further, when the video tracks are alternative versions of video, the video may be switched at a key frame of the video tracks to minimize the disruption in the video output. Encoded data for the video track is routed to the video rendering pipeline, and playback of the video track is synchronized with playback of the selected audio track using the clock source to drive synchronization.

When a second audio track is selected for the same audio rendering pipeline, the encoded data for the second audio track is routed to the audio rendering pipeline that includes the clock source. Thus, playback of the second audio track is synchronized with playback of the video track using the clock source to drive synchronization, where the clock source is maintained despite switching audio tracks.

Or, when a second audio track is selected, playback of the second audio track can be synchronized with playback of the first video track and playback of the first audio track using the clock source to drive synchronization. Since the clock source drives the synchronization, and not any of the audio tracks or video track themselves, as long as the clock source remains active, audio tracks may be switched in and out. Thus, the clock source is maintained despite switching audio tracks. Similarly, even as source buffers are added or removed, the same clock source can be maintained.

Although in the previous examples a single clock source is used, the clock source may change dynamically. That is, during media streaming, another clock source in another one of the rendering pipeline(s) may be determined. Typically, a clock source for an audio rendering pipeline is still used, however, since adjusting video by adding or dropping frames to correct synchronization tends to be easier than adjusting audio to correct synchronization.

### Exemplary Architecture for Switching Module

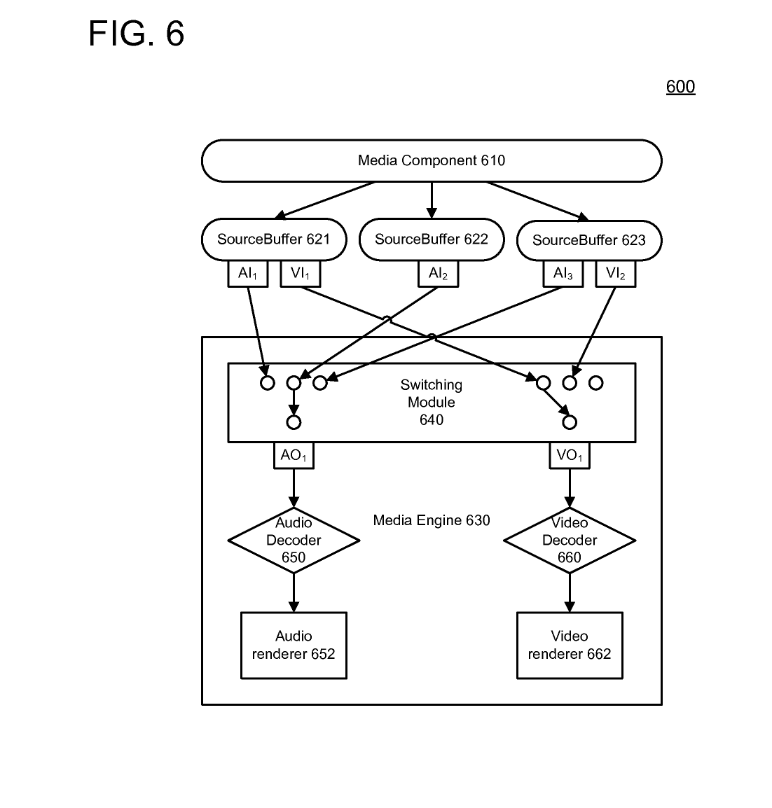

FIG. 6 illustrates an architecture with a switching module for media streaming, where only one audio renderer and one video renderer are present. FIG. 6 shows a media component (610), multiple source buffers (621, 622, 623), and a media engine (630). The media engine (630) includes an audio rendering pipeline, a video rendering pipeline, and a switching module (640).

The source buffers (621, 622, 623) are hosted by the media component (610). For example, the media component (610) implements Media Source Extensions (“MSE”), a W3C extension to the HTMLMediaElement APIs that enables adaptive media streaming and live streaming. In some implementations, the media component (610) communicates across an API with the media engine (630), which is part of an operating system of a computer system. Among other features, the implementation of MSE allows a browser to support web-based media streaming services using video/audio tags. However, the media component (610) is not limited to MSE implementations, and may be any media component capable of enabling media streaming. Similarly, the media engine (630) need not be part of an operating system of a computer system, but instead can be provided through a media processing tool available on the computer system.

The source buffers (621, 622, 623) temporarily store encoded media information for media tracks. Encoded media information is provided by the media component (610), buffered in the source buffers (621, 622, 623) and provided for routing by the switching module (640) at an expected rate (assuming the encoded media information is provided from a network or other source to the source buffer). A source buffer (621, 622, 623) can contain data for one or more media tracks. A source buffer (621, 622, 623) can maintain a list of chunks of encoded media information, adding chunks to the list as encoded media information is received, reordering chunks as appropriate, and removing chunks from the list as encoded media information is routed to a rendering pipeline.

Each source buffer (621, 622, 623) provides one or more audio and/or video inputs as selection inputs for routing by the switching module (640). In FIG. 6, the switching module (640) is part of the media engine (630), the playback engine of the media system. For example, the switching module (640) is an implementation of MSE stream switch source. The switching module (640) is not limited to MSE implementations, however.

In FIG. 6, audio inputs AI₁, AI₂, and AI₃ and video inputs VI₁ and VI₂ are shown. However, the number of audio and video inputs are not limited to these specific inputs, and there may be more or fewer audio inputs and/or video inputs. Further, in FIG. 6, the number of source buffers is 3, but may instead be another number of source buffers. Thus, there may be an arbitrary number of source buffers and audio and video tracks as selection inputs to the switching module (640). In addition, the source buffers and audio and video track are dynamic and may vary during the media streaming.

The switching module (640) includes one or more switches. In FIG. 6, the switching module (640) includes two switches. Alternatively, the switching module (640) may include more or fewer switches. A given switch has one or more selection inputs, where a selection input represents encoded data for a media track from one of the source buffers (621, 622, 623). A given switch also has a selection output associated with a rendering pipeline. The selection outputs for different switches are associated with different rendering pipelines for decoding and rendering.

The switching module (640) determines which of the input audio tracks to route to the audio rendering pipeline (including audio decoder (650) and audio renderer (652)), and routes the selected audio track as selection output AO₁. The switching module (640) also determines which of the video tracks to route to the video rendering pipeline (including video decoder (660) and video renderer (662)), and routes the selected video track as selection output VO₁. The switching module (640) is also responsible for adding and removing media tracks by managing and communicating the media data when a new source buffer is added, new media track data is added to an existing source buffer hosted by the media component (610), a source buffer is removed, or media track data is removed from an existing source buffer hosted by the media component (610). With this configuration, the rendering pipelines themselves are fixed and do not change dynamically.

Media track information can be conveyed by the switching module (640) to the media engine (630), to indicate which media tracks are available, indicate properties of the available media tracks, etc. The media engine (630) may in turn expose the media track information through a graphical user interface to an end user or provide the media track information to a media playback application for presentation through a user interface of the application. The media engine (630) and switching module (640) can maintain a map between stream identifiers within the media engine (630) and track identifiers exposed by the media engine (630) to the end user or media playback applications.

The end user or media playback application can then select one or more media tracks, with the media engine (630) relaying such track selection information back to the switching module (640). When a source buffer is changed or media tracks are changed, the switching module (640) provides updated media track information to the media engine (630) accordingly.

The media engine (630) also provides signals/events to media playback applications when switching operations or other track-related operations are completed, as indicated by the switching module (640). An application in turn can rely on the signals to take further actions (e.g., update the user interface for the application).

In FIG. 6, the switching module (640) routes one output audio track and one output video track, AO₁ and VO₁, respectively. In this case, the media engine (630) is configured to play a single audio track and single video track at once. The choice of tracks to render is made through the switching module (640). The selected audio track AO₁ is routed to the audio rendering pipeline, which includes an audio decoder (650) and an audio renderer (652). The audio decoder (650) can decode according to the AAC format, HE AAC format, a Windows Media Audio format, or other format for decoding audio. The audio decoder (650) decodes encoded audio information for the selected audio track AO₁, and provides decoded audio to the audio renderer (652). In FIG. 6, the data in the stream routed to the audio rendering pipeline can change depending on which input audio track is selected. The selected video track VO₁ is routed to the video rendering pipeline, which includes a video decoder (660) and a video renderer (662). The video decoder (660) can decode according to the H.264/AVC format, VC-1 format, VP8 format, or other format for decoding video. The video decoder (660) decodes encoded video information for the selected video track VO₁, and provides decoded video to the video renderer (662).

The data in the stream connected to the audio renderer (652) is used by the media engine (630) or other component of the system to provide a continuous audio clock associated with the audio renderer (662). The audio clock can then be used as a reference point for synchronized video rendering.

All of the rendering pipelines need not be active. A selection input can be a “null” input. For example, output video track VO₁ need not route an input video track to be decoded and rendered.

In some implementations, regardless of whether a “live” audio input is routed to it, the audio rendering pipeline remains available to output audio. In this case, a media foundation (“MF”) source can send tick events for a given input audio stream so that the MF source may complete preroll successfully. Prerolling is the process of giving data to a media sink before the presentation clock starts. If the given audio input stream ever becomes active, the MF source will generate a format change request to the audio decoder prior to sending any data.

When the switching module (640) switches input video streams, the switching module (640) addresses potential overlap between the two video streams.

When switching video streams from a current stream to a different stream, the switching module (640) identifies a random access point in the different stream that is close to the time position of a switching point. The switching module (640) then sends video stream samples starting from the identified random access point. When the random access point is prior to the actual switching point, the video stream samples will be decoded as fast as possible by the decoder but not rendered until the first video stream sample that matches the audio clock at the switching point is available.

The switching module (640) can send an event signal to indicate the switching operation has started as well as an estimate of the potential time latency, and then another event signal when the switching has completed. The media playback application can use the signals to manage necessary UI updates and also other potential mitigation on the UI if the switching is not expected to be seamless, e.g., within one video frame interval.

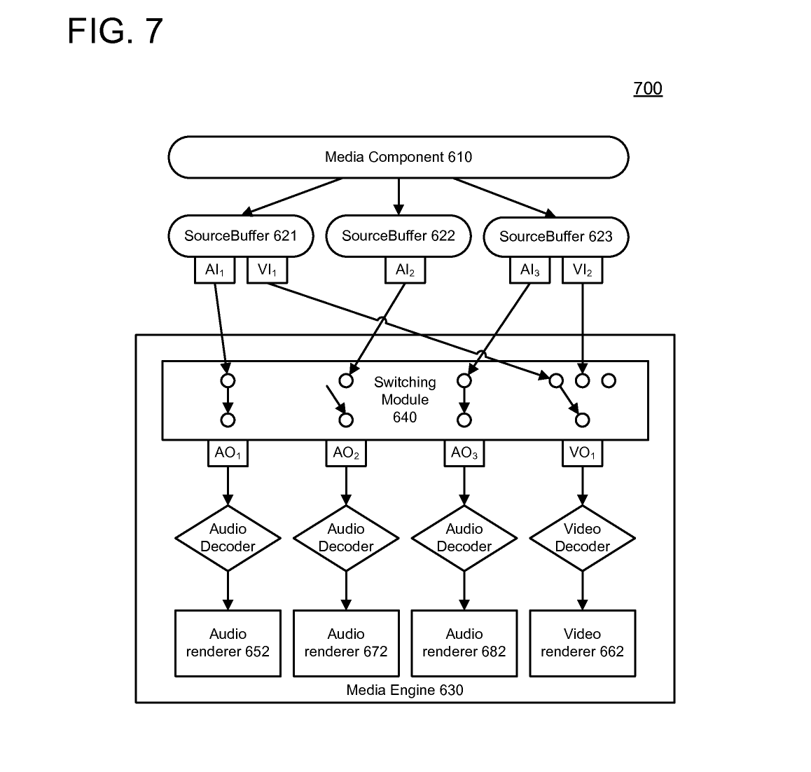

FIG. 7 illustrates an architecture with a switching module for media streaming, where multiple audio renderers and one video renderer are present. As in FIG. 6, FIG. 7 shows a media component (610), multiple source buffers (621, 622, 623), and a media engine (630). The media engine (630) includes a switching module (640), a video rendering pipeline, and three audio rendering pipelines. Each of the audio rendering pipelines includes an audio decoder and audio renderer (652, 672, 682). The different audio rendering pipelines can be associated with different audio outputs (e.g., headphones, speakers). Or, different audio rendering pipelines can be associated with the same audio output, with audio mixed for output if necessary. Different audio rendering pipelines can share certain components (e.g., decoder).

As shown in FIG. 7, the media engine (630) can support concurrent playback of more than one output audio track. In FIG. 7, the media engine (630) supports concurrent playback of three output audio tracks (AO₁, AO₂, AO₃). Once the number of audio rendering pipelines is set for a playback session, the number of audio rendering pipelines is fixed for the duration of the playback session.

Again, however, all of the rendering pipelines need not be active. For example, in the routing shown in FIG. 7, output audio track AO₂ does not route any input audio track to be decoded and rendered.

The switching module (640) can manage even more audio tracks. The number of audio tracks can exceed the number of audio rendering pipelines. For example, each of multiple output audio tracks may contain a different language audio track for a given program, where one audio rendering pipeline decodes and renders the selected language audio track. Or, each of multiple output media tracks may contain a different bitrate/quality version for a given program, where one rendering pipeline decodes and renders the selected language track. Alternative versions can be provided through the same source buffer or different source buffers.

In any case, in some implementations, a clock of a single audio rendering pipeline is selected to keep the media tracks synchronized. The switching module (640) ensures that at least one of the output audio tracks is always active, so that the audio rendering pipeline can provide the audio clock. Alternatively, the media engine (630) may allow the clock source to change dynamically, nevertheless ensuring that a video stream uses a clock derived from audio hardware.

Alternatively, the media engine (630) includes multiple video rendering pipelines. For example, video can be rendered in multiple windows or multiple sections of a web browser.

### Example Computer Systems

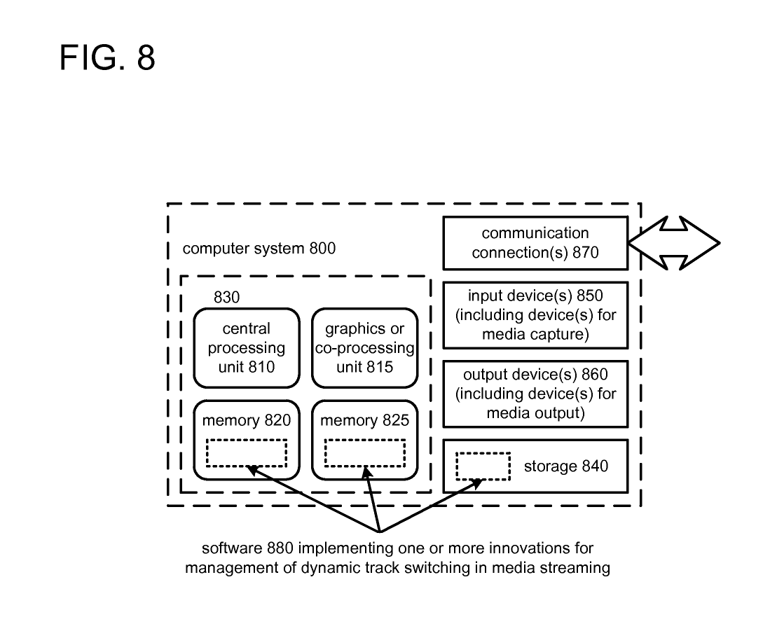

FIG. 8 illustrates a generalized example of a suitable computer system (800) in which several of the described innovations may be implemented. The computer system (800) is not intended to suggest any limitation as to scope of use or functionality, as the innovations may be implemented in diverse general-purpose or special-purpose computer systems. Thus, the computer system can be any of a variety of types of computer system (e.g., desktop computer, laptop computer, tablet or slate computer, smartphone, gaming console, etc.).

With reference to FIG. 8, the computer system (800) includes one or more processing units (810, 815) and memory (820, 825). The processing units (810, 815) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 8 shows a central processing unit (810) as well as a graphics processing unit or co-processing unit (815).

The tangible memory (820, 825) may be volatile memory (e.g., registers, cache, RAM), non-volatile memory (e.g., ROM, EEPROM, flash memory, etc.), or some combination of the two, accessible by the processing unit(s). The memory (820, 825) stores software (880) implementing one or more innovations for managing dynamic track switching in media streaming, in the form of computer-executable instructions suitable for execution by the processing unit(s). The memory (820, 825) also includes source buffers that store encoded media information for one or more media tracks.

A computer system may have additional features. For example, the computer system (800) includes storage (840), one or more input devices (850), one or more output devices (860), and one or more communication connections (870). An interconnection mechanism (not shown) such as a bus, controller, or network interconnects the components of the computer system (800). Typically, operating system software (not shown) provides an operating environment for other software executing in the computer system (800), and coordinates activities of the components of the computer system (800). For example, the operating system can include a media engine that manages playback of media tracks from one or more source buffers using a media switching source and one more rendering pipelines. For the rendering pipelines, the operating system can include one or more audio decoders, one or more audio rendering modules, one or more video decoders, one or more video rendering modules as part of the media engine or separately. Or, special-purpose hardware can include an audio decoder, audio rendering module, video decoder and/or video rendering module.

In particular, the other software available at the computer system (800) includes one or more media playback applications that use media rendering pipelines of the computer system (800). The media playback applications can include an audio playback application, video playback application, communication application or game. The media engine can provide metadata about media tracks to a media playback application, receive input from the media playback application, and mediate use of a rendering pipeline by the media playback application. In addition to media playback applications, the other software can include common applications (e.g., email applications, calendars, contact managers, games, word processors and other productivity software, Web browsers, messaging applications).

The tangible storage (840) may be removable or non-removable, and includes magnetic disks, magnetic tapes or cassettes, CD-ROMs, DVDs, or any other medium which can be used to store information in a non-transitory way and which can be accessed within the computer system (800). The storage (840) stores instructions for the software (880) implementing one or more innovations for managing dynamic track switching in media streaming.

The input device(s) (850) include one or more audio input devices (e.g., a microphone adapted to capture audio or similar device that accepts audio input in analog or digital form) and one or more video input devices (e.g., a camera adapted to capture video or similar device that accepts video input in analog or digital form). The input device(s) (850) may also include a touch input device such as a keyboard, mouse, pen, or trackball, a touchscreen, a scanning device, or another device that provides input to the computer system (800). The input device(s) (850) may further include a CD-ROM or CD-RW that reads audio samples into the computer system (800). The output device(s) (860) typically include one or more audio output devices (e.g., one or more speakers) associated with one or more audio rendering pipelines, as well as one or more video output devices (e.g., display, touchscreen) associated with one or more video rendering pipelines. The output device(s) (860) may also include a CD-writer, or another device that provides output from the computer system (800).

The communication connection(s) (870) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computer system (800), computer-readable media include memory (820, 825), storage (840), and combinations of any of the above.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or device can be local or distributed, and can include any combination of special-purpose hardware and/or general-purpose hardware with software implementing the functionality described herein.

The disclosed methods can also be implemented using specialized computer hardware configured to perform any of the disclosed methods. For example, the disclosed methods can be implemented by an integrated circuit (e.g., an ASIC such as an ASIC digital signal process unit (“DSP”), a graphics processing unit (“GPU”), or a programmable logic device (“PLD”) such as a field programmable gate array (“FPGA”)) specially designed or configured to implement any of the disclosed methods.

For the sake of presentation, the detailed description uses terms like “determine” and “apply” to describe computer operations in a computer system. These terms are high-level abstractions for operations performed by a computer, and should not be confused with acts performed by a human being. The actual computer operations corresponding to these terms vary depending on implementation. As used herein, the terms “provide” and “provided by” mean any form of delivery, whether directly from an entity or indirectly from an entity through one or more intermediaries.

### Alternatives and Variations

Various alternatives to the foregoing examples are possible.

Although operations described herein are in places described as being performed for audio and video playback, in many cases the operations can alternatively be performed for another type of media information (e.g., image display in a slideshow).

Although the operations of some of the disclosed techniques are described in a particular, sequential order for convenient presentation, it should be understood that this manner of description encompasses rearrangement, unless a particular ordering is required. For example, operations described sequentially may in some cases be rearranged or performed concurrently. Also, operations can be split into multiple stages and, in some cases, omitted.

The various aspects of the disclosed technology can be used in combination or separately. Different embodiments use one or more of the described innovations. Some of the innovations described herein address one or more of the problems noted in the background. Typically, a given technique/tool does not solve all such problems.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. One or more computer-readable media storing computer-executable instructions for causing a processor programmed thereby to implement a switching module adapted to:
configure one or more switches between one or more source buffers and one or more rendering pipelines, each of the one or more switches having:
one or more selection inputs each representing encoded data for a media track from one of the one or more source buffers; and
a selection output associated with a different one of the one or more rendering pipelines for decoding and rendering; and
use the one or more switches to manage which of the media tracks, if any, have encoded data routed to the one or more rendering pipelines during media streaming.

2. The one or more computer-readable media of claim 1, wherein each of the one or more source buffers temporarily stores encoded data for one or more media tracks.

3. The one or more computer-readable media of claim 1, wherein at least one of the one or more switches has multiple selection inputs, and wherein at least one of the one or more switches has a single selection input.

4. The one or more computer-readable media of claim 1, wherein each of the one or more rendering pipelines includes a media decoder and a media renderer.

5. The one or more computer-readable media of claim 1, wherein the switching module is further adapted to, as part of management of the media tracks during the media streaming:
switch which media track has encoded data routed to one of the one or more rendering pipelines.

6. The one or more computer-readable media of claim 1, wherein the switching module is further adapted to, as part of management of the media tracks during the media streaming:
add or remove a media track as selection input of one of the one or more switches.

7. The one or more computer-readable media of claim 1, wherein the switching module is further adapted to:
add or remove a source buffer, including updating selection inputs of one or more of the one or more switches.

8. The one or more computer-readable media of claim 1, wherein the switching module is further adapted to:
deliver metadata about the media tracks to a media engine, the metadata indicating properties of at least some of the media tracks, wherein the properties include at least one of language and number of channels; and
receive track selection input from the media engine, the track selection input indicating how to use the one or more switches to manage the media tracks.

9. The one or more computer-readable media of claim 8, wherein the switching module is further adapted to:
update metadata about the media tracks to the media engine after switching of one of the media tracks, addition of one of the media tracks, removal of one of the media tracks, addition of one of the one or more source buffers or removal of one of the one or more source buffers.

10. The one or more computer-readable media of claim 1, wherein the one or more rendering pipelines are fixed during the media streaming, and the one or more source buffers are dynamic during the media streaming.

11. The one or more computer-readable media of claim 1, wherein the switching module is part of a media engine of an operating system, and wherein the media engine is adapted to provide status information to media playback applications about track-related operations.

12. The one or more computer-readable media of claim 1, wherein the one or more rendering pipelines include a video rendering pipeline and one or more audio rendering pipelines.

13. The one or more computer-readable media of claim 12, wherein the media tracks include one or more audio tracks and one or more video tracks, wherein the switching module is part of a media engine adapted to determine a clock source in one of the one or more audio rendering pipelines, and wherein the switching module is further adapted to, as part of management of the media tracks during the media streaming:
select a first audio track of the one or more audio tracks, wherein encoded data for the first audio track is routed to the audio rendering pipeline that includes the clock source; and
select a first video track of the one or more video tracks, wherein encoded data for the first video track is routed to the video rendering pipeline, and wherein playback of the first video track is synchronized with playback of the first audio track using the clock source to drive synchronization.

14. The one or more computer-readable media of claim 13, wherein the switching module is further adapted to, as part of management of the media tracks during the media streaming:
select a second video track of the one or more video tracks, wherein encoded data for the second video track is routed to the video rendering pipeline, and wherein playback of the second video track is synchronized with playback of the first audio track using the clock source to drive synchronization.

15. The one or more computer-readable media of claim 13, wherein the switching module is further adapted to, as part of management of the media tracks during the media streaming:
select a second audio track of the one or more audio tracks, wherein encoded data for the second audio track is routed to the audio rendering pipeline that includes the clock source, and wherein playback of the second audio track is synchronized with playback of the first video track using the clock source to drive synchronization, whereby the clock source is maintained despite switching among the one or more audio tracks.

16. The one or more computer-readable media of claim 13, wherein the switching module is further adapted to, as part of management of the media tracks during the media streaming:
select a second audio track of the one or more audio tracks, wherein encoded data for the second audio track is routed to an audio rendering pipeline that does not includes the clock source, and wherein playback of the second audio track is synchronized with playback of the first video track and playback of the first audio track using the clock source to drive synchronization, whereby the clock source is maintained despite selection of the second audio track.

17. The one or more computer-readable media of claim 13, wherein the media engine is further adapted to, during the media streaming, determine another clock source in one of the one or more audio rendering pipelines.

18. The one or more computer-readable media of claim 13, wherein the clock source is from a sound card.

19. A method comprising:
with a computer system, instantiating a switching module;
configuring plural switches of the switching module between plural source buffers and plural rendering pipelines, each of the plural switches having:
one or more selection inputs each representing encoded data for a media track from one of the plural source buffers; and
a selection output associated with a different one of the plural rendering pipelines; and
using the plural switches to manage which of the media tracks, if any, have encoded data routed to the plural rendering pipelines during media streaming.

20. A computer system comprising a processor and memory, wherein the computer system implements a streaming media processing pipeline comprising:
one or more source buffers;
a media engine separated by an application programming interface from the one or more source buffers, wherein the media engine includes one or more rendering pipelines and a switching module, wherein the one or more rendering pipelines include a video rendering pipeline and one or more audio rendering pipelines, wherein the video rendering pipeline includes a video decoder and a video renderer, wherein each of the one or more audio rendering pipelines includes an audio decoder and an audio renderer, and wherein the switching module is adapted to:
configure one or more switches between the one or more source buffers and the one or more rendering pipelines, each of the one or more switches having:
one or more selection inputs each representing encoded data for a media track from one of the one or more source buffers; and
a selection output associated with a different one of the one or more rendering pipelines; and
use the one or more switches to manage which of the media tracks, if any, have encoded data routed to the one or more rendering pipelines during media streaming, wherein the switching module is further adapted to, as part of management of the media tracks during the media streaming:
switch which media track has encoded data routed to one of the one or more rendering pipelines; and
add or remove a media track as a selection input of one of the one or more switches.
